(19) United States
(12) Patent Application Publication
(10) Pub. No.: US 2013/0196139 A1
(43) Pub. Date: Aug. 1, 2013

(54) COATED ARTICLE WITH ANTIREFLECTION COATING INCLUDING FULLERENE STRUCTURES, AND/OR METHODS OF MAKING THE SAME

(71) Applicants: Mark A. Lewis, Ypsilanti, MI (US); Liang Liang, Taylor, MI (US)

(72) Inventors: Mark A. Lewis, Ypsilanti, MI (US); Liang Liang, Taylor, MI (US)

(21) Appl. No.: 13/360,898

(22) Filed: Jan. 30, 2012

(51) Int. Cl. B32B 17/06; B05D 3/02; B32B 3/26; B05D 5/06; B32B 5/16; B82Y 20/00; B82Y 30/00; B82Y 40/00

(52) U.S. Cl. 428/312.6; 427/165; 428/428; 428/323; 977/734; 977/735; 977/742

(57) ABSTRACT

In certain examples, a porous silica-based matrix may be formed. In an exemplary embodiment, using sol gel methods, a coating solution of or including metal alkoxides such as TEOS and carbon-based structures such as fullerene structures may be used to form a layer(s) of or including silica and fullerene compounds in a solid matrix on (directly or indirectly) a glass substrate. The coated article may be heat treated (e.g., thermally tempered), which may cause the carbon-based fullerene structures to combust, resulting in a porous silica-based matrix. The layer of the porous silica-based matrix may be used as a broadband anti-reflective coating.

Certain example embodiments of this invention relate to a method of making an antireflective (AR) coating supported by a glass substrate. The AR coating includes, in certain exemplary embodiments, porous metal oxide(s) and/or silica, and may be produced using a sol-gel process. The porosity of the coating may be controlled by adding fullerene structures (e.g., of or including single wall and/or multiple wall (SWNT and/or MWNT) carbon nanotubes (CNT), buckyball structures, other fullerene based spheroids, carbon nanobuds, and/or any other structures made of or including thin layers based on carbon) or other combustible material/structures to the coating solution, such that the coating prior to any optional heat treatment comprises a fullerene and metal oxide and/or silica-based matrix. The coated article may then be heat treated (e.g., thermally tempered) so as to combust (partially or fully burn off) the fullerene structures (and/or other combustible structures), such that the spaces where the fullerene structures were located prior to heat treatment become pores after heat treatment. The AR coating may, for example, be deposited on glass used as a substrate or superstrate for the production of photovoltaic devices or other electronic devices, although it also may used in other applications.

### BACKGROUND AND SUMMARY OF EXAMPLE EMBODIMENTS

Glass is desirable for numerous properties and applications, including optical clarity and overall visual appearance. For some example applications, certain optical properties (e.g., light transmission, reflection and/or absorption) are desired to be optimized. For example, in certain example instances, reduction of light reflection from the surface of a glass substrate may be desirable for storefront windows, electronic devices, monitors/screens, display cases, photovoltaic devices such as solar cells, picture frames, other types of windows, and so forth.

Photovoltaic devices such as solar cells (and modules therefor) are known in the art. Glass is an integral part of most common commercial photovoltaic modules, including both crystalline and thin film types. A solar cell/module may include, for example, a photoelectric transfer film made up of one or more layers located between a pair of substrates. One or more of the substrates may be of glass, and the photoelectric transfer film (typically semiconductor) is for converting solar energy to electricity. Example solar cells are disclosed in U.S. Pat. Nos. 4,510,344, 4,806,436, 6,506,622, 5,977,477, and JP 07-122764, the disclosures of which are all hereby incorporated herein by reference in their entireties.

Substrate(s) in a solar cell/module are often made of glass. Incoming radiation passes through the incident glass substrate of the solar cell before reaching the active layer(s) (e.g., photoelectric transfer film such as a semiconductor) of the solar cell. Radiation that is reflected by the incident glass substrate does not make its way into the active layer(s) of the solar cell, thereby resulting in a less efficient solar cell. In other words, it would be desirable to decrease the amount of radiation that is reflected by the incident substrate, thereby increasing the amount of radiation that makes its way through the incident glass substrate (the glass substrate closest to the sun) and into the active layer(s) of the solar cell. In particular, the power output of a solar cell or photovoltaic (PV) module may be dependant upon the amount of light, or number of photons, within a specific range of the solar spectrum that pass through the incident glass substrate and reach the photovoltaic semiconductor.

Because the power output of the module may depend upon the amount of light within the solar spectrum that passes through the glass and reaches the PV semiconductor, attempts have been made to boost overall solar transmission through the glass used in PV modules. One attempt is the use of iron-free or “clear” glass, which may increase the amount of solar light transmission when compared to regular float glass, through absorption minimization. Such an approach may or may not be used in conjunction with certain embodiments of this invention.

In certain example embodiments of this invention, an attempt to address the aforesaid problem(s) is made using an antireflective (AR) coating on a glass substrate (the AR coating may be provided on either side, or both sides, of the glass substrate in different embodiments of this invention). An AR coating may increase transmission of light through the light incident substrate, and thus the increase the power and efficiency of a PV module in certain example embodiments of this invention.

In many instances, glass substrates have an index of refraction of about 1.52, and typically about 4% of incident light may be reflected from the first surface. Single-layered coatings of transparent materials such as silica and alumina having a refractive index of equal to the square root of that of glass (e.g., about 1.23+/−10%) may be applied to minimize or reduce reflection losses and enhance the percentage of light transmission through the incident glass substrate. The refractive indices of silica and alumina are about 1.46 and 1.6, respectively, and thus these materials alone in their typical form may not meet this low index requirement in certain example instances.

In certain example embodiments of this invention, pores are formed in such materials or the like. In particular, in certain example embodiments of this invention, porous inorganic coated films may be formed on glass substrates in order to achieve broadband anti-reflection (AR) properties. Because refractive index is related to the density of coating, it may be possible to reduce the refractive index of a coating by introducing porosity into the coating. Pore size and distribution of pores may significantly affect optical properties. Pores may preferably be distributed homogeneously in certain example embodiments, and the pore size of at least some pores in a final coating may preferably be substantially smaller than the wavelength of light to be transmitted. For example, it is believed that about 53% porosity (+/− about 10%, more preferably +/− about 5% or 2%) may be required in order to lower the refractive index of silica-based coatings from about 1.46 to about 1.2 and that about 73% porosity (+/− about 10%, more preferably +/− about 5% or 2%) may be required to achieve alumina based coatings having about the same low index.

The mechanical durability of coatings, however, may be adversely affected with major increases in porosity. Porous coatings also tend to be prone to scratches, mars etc. Thus, in certain example embodiments of this invention, there may exist a need for methods and AR coatings that are capable of realizing desired porosity without significantly adversely affecting mechanical durability of the AR coatings.

Certain example embodiments of this invention may relate to a method of making a coated article including a broadband anti-reflective coating comprising porous silica on, directly or indirectly, a glass substrate. In certain instances, the method may comprise forming a coating solution comprising a silane, fullerene structures comprising at least one functional group, and a solvent; forming a coating on, directly or indirectly, the glass substrate by disposing the coating solution on the glass substrate; drying the coating and/or allowing the coating to dry so as to form a coating comprising silica and a fullerene structure-based matrix on the glass substrate; heat treating the glass substrate with the coating comprising silica and fullerene structure-based matrix thereon so as to combust the fullerene structures, leaving pores following said heat treating in locations where the fullerene structures had been prior to said heat treating, so as to form an anti-reflective coating comprising a porous silica-based matrix on the glass substrate.

Other example embodiments relate to a method of making an anti-reflective coating, the method comprising: providing a coating solution comprising at least a metal oxide, carbon-inclusive structures, and a solvent; disposing the coating solution on a glass substrate so as to form a coating comprising a metal oxide and carbon-inclusive structure-based matrix; and heat treating the substrate with the coating thereon so as to combust the carbon-inclusive structures, so that after the heat treating pores are located substantially where the carbon-inclusive structures had been prior to the heat treating, so as to form a coating comprising a porous metal oxide.

Further example embodiments relate to a coated article comprising a glass substrate with an anti-reflective coating disposed thereon; wherein the anti-reflective coating comprises porous silica, and comprises pores having carbon residue.

Still further example embodiments relate to a method of making a coated article including an anti-reflective coating comprising porous silica on, directly or indirectly, a glass substrate. The method comprises: forming a coating solution comprising a silane, carbon-inclusive structures, and a solvent; forming a coating on, directly or indirectly, the glass substrate by disposing the coating solution on the glass substrate; drying the coating and/or allowing the coating to dry so as to form a coating comprising silica and a matrix comprising the carbon-inclusive structures on the glass substrate; heat treating the glass substrate with the coating comprising silica and the matrix comprising the carbon-inclusive structures thereon so as to combust the carbon-inclusive structures, leaving spaces and/or pores following said heat treating in locations where the carbon-inclusive structures had been prior to said heat treating, so as to form an anti-reflective coating comprising a silica-based matrix on the glass substrate.

### BRIEF DESCRIPTION OF THE DRAWINGS

FIG. 1 shows a cross-sectional view of a single-layered anti-reflective coating according to certain embodiments;

FIGS. 2(a)-(e) illustrate different examples of fullerene structures;

FIG. 3 illustrates an example reaction between a fullerene structure and a metal oxide-inclusive compound to produce an example of a fullerene structure- and metal oxide-based matrix;

FIG. 4 illustrates an example condensation reaction between a CNT and a silane-inclusive compound to produce an example fullerene structures- and silica-based matrix;

FIG. 5 shows a cross-sectional view of a coating comprising a network of fullerene structures and a silane-based compound according to certain example embodiments;

FIG. 6 shows a cross-sectional view of an anti-reflective coating comprising a silane-based compound with pores created by fullerene structures that have been removed, according to certain example embodiments; and

FIG. 7 illustrates a method for making an improved anti-reflective coating according to certain example embodiments.

### DETAILED DESCRIPTION OF THE INVENTION

Referring now more particularly to the accompanying drawings in which like reference numerals indicate like parts throughout the several views.

Certain example embodiments relate to antireflective (AR) coatings that may be provided for coated articles used in devices such as photovoltaic devices, storefront windows, display cases, picture frames, greenhouses, electronic devices, monitors, screens, other types of windows, and the like. In certain example embodiments (e.g., in photovoltaic devices), the AR coating may be provided on either the light incident side and/or the other side of a substrate (e.g., glass substrate), such as a front glass substrate of a photovoltaic device. In other example embodiments, the AR coatings described herein may be used in the context of sport and stadium lighting (as an AR coating on such lights), and/or street and highway lighting (as an AR coating on such lights) in certain example instances.

In certain example embodiments, an improved anti-reflection (AR) coating is provided on an incident glass substrate of a solar cell or the like. This AR coating may function to reduce reflection of light from the glass substrate, thereby allowing more light within the solar spectrum to pass through the incident glass substrate and reach the photovoltaic semiconductor so that the photovoltaic device (e.g., solar cell) can be more efficiently. In certain example embodiments, such an AR coating is used in applications such as storefront windows, electronic devices, monitors/screens, display cases, photovoltaic devices such as solar cells, picture frames, other types of windows, and so forth.

The glass substrate may be a glass superstrate or any other type of glass substrate in different instances.

In certain example embodiments, porous inorganic AR coatings may be made by (1) a porogen approach using micelles as a template in a metal (e.g., Si, Al, Ti, etc.) alkoxide matrix; (2) inorganic or polymeric particles with metal alkoxides as binders; (3) inorganic nanoparticles with charged polymers as binder, and/or (4) hollow silica nanoparticles.

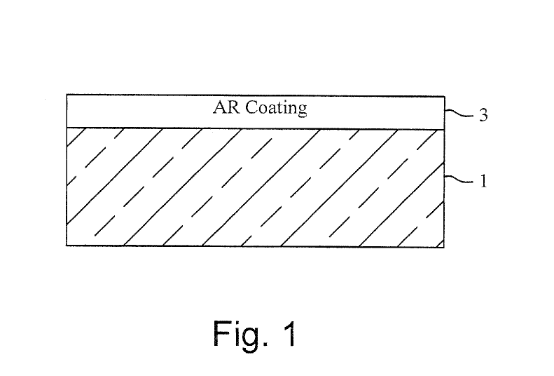

FIG. 1 is a side cross-sectional view of a coated article according to an example non-limiting embodiment of this invention. The coated article includes substrate 1 (e.g., clear, green, bronze, or blue-green glass substrate from about 1.0 to 10.0 mm thick, more preferably from about 1.0 mm to 3.5 mm thick), and anti-reflective coating 3 provided on the substrate 1 either directly or indirectly. The anti-reflective coating 3 may comprise a single or multiple porous silica-based matrix. Example methods of making a porous silica-based anti-reflective coating 3 are described in detail herein.

It has been found that in certain examples, the pore size and/or porosity of the particles in a coating may play a role in tuning the optical performance of AR coated glass substrates. In certain cases, it has been found that when pore sizes in the coating that are less than about 50 nm (e.g., ranging from about 1 to 50 nm, more preferably from about 2 to 25 nm, and most preferably from about 2.4 nm to 10.3 nm), the porosity of the corresponding films can vary widely. In certain examples, the porosity of a coating is the percent of the coating that is void space. For example, when the pore size is from about 2.4 to 10.3 nm, the porosity may vary over a range of about 10% or more—e.g., from about 27.6% to 36%. Higher porosity may in some cases yield films with lower indices of refraction, but with tradeoffs in (e.g., compromised) durability. Furthermore, experimental data obtained from changing the size and ratio of different spherical particles in conjunction with the amount of binder used that fills in the geometrical space between particles may also indicate that the film structure and porosity of an AR coating may have an effect on optical performance. Thus, it may be advantageous to control the film structure and/or porosity of an AR coating in order to produce desired optical properties. Accordingly, there is provided a technique of creating pore space in a silica-based matrix that may achieve improved AR optical performance and/or film durability.

In certain example embodiments, the tailoring of pore size and/or porosity of AR coated films may be achieved by controlling the size of surfactants, polymers, and/or nanoparticles. In other examples, the pore size and/or porosity of an AR coating may be modified by introducing carbon-inclusive particles such as hollow particles inside the silica-based matrix of at least one of the layer(s) of the coating (or most/all of the coating). In certain embodiments, the intrinsic pore structure created by the size and shape of hollow nanoparticles additives may improve the capability to control the pore size and/or porosity of the coating following heat treatment, where the particles are at least partially burned off during the heat treatment (e.g., thermal tempering).

It has advantageously been found that in certain example embodiments, adding carbon-inclusive materials such as fullerene structures to a sol gel-based metal (e.g., Si, Al, Ti, etc.) oxide/alkoxide system may result in an improved AR coating. Certain example embodiments described herein relate to a method of making such an improved AR coating.

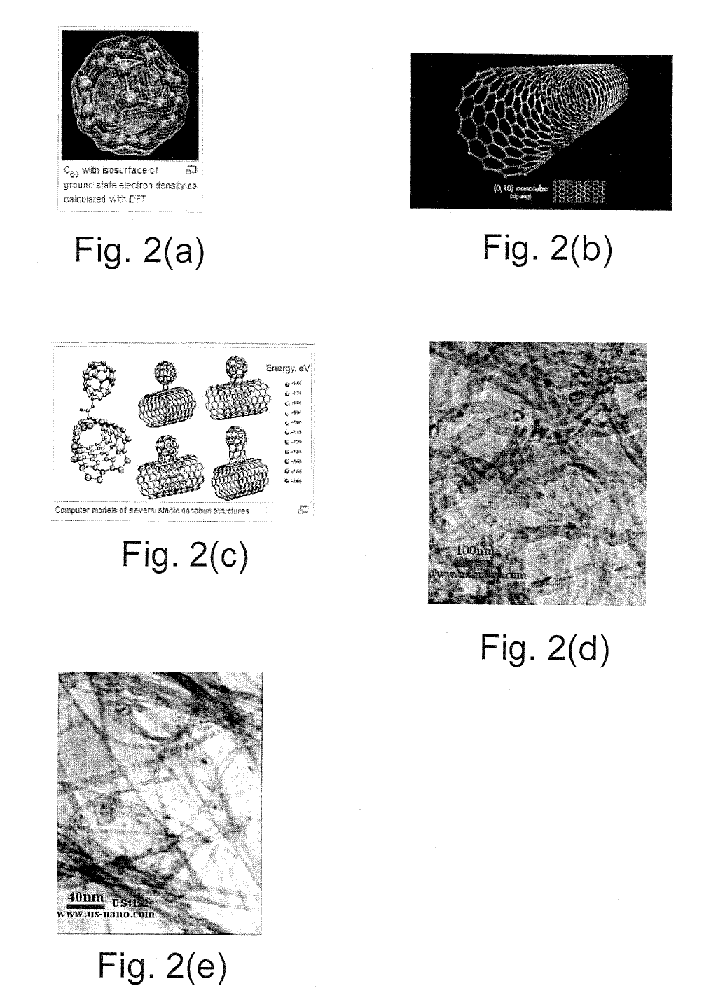

FIG. 2(a)-2(e) illustrate various types of fullerene structures.

In certain example embodiments, “fullerene structures” as disclosed herein may refer to materials such as carbon-based structures comprising carbon nanotubes (CNT)—single wall and/or multiple wall nanotubes (SWNT and/or MWNT), buckyball spherical structures, other fullerene spheroids, carbon nanobuds, and/or any other structures made of or including thin layers based on carbon. In certain example embodiments, by using fullerene structures in an AR coating (e.g., a silicon oxide-based AR coating), the pore size and/or porosity of the AR coating may advantageously be adjusted more precisely and/or over a wider range. Furthermore, in certain example embodiments, the refractive index of the coating may be tuned by choosing a desired porosity, but obtaining said porosity with smaller pores. In certain instances, making a coating having a particular porosity by using smaller (but a greater number of) pores, or “pores” with a smaller diameter/width but longer length, may result in a coating with improved durability. For example, in certain example embodiments, the average width of a pore may be less than about 2 nm, more preferably less than about 1 nm, and in certain embodiments, less than about 0.5 nm. In certain embodiments, such as when carbon nanotubes are used as the fullerene structure to be partially and/or fully burned off, the resulting pores may be smaller in diameter than pores made from using other methods, but due to the length of the pores, the desired porosity may be achieved.

Moreover, in certain example embodiments, hollow particles (e.g., fullerene structures) of a particular size(s) and/or shape(s) may be chosen based on the pore structure(s) and/or size(s) desired for the final coating. In certain examples, this may advantageously enable the refractive index of an AR coating to be more finely tuned. In certain example embodiments, other types of combustible materials, structures or particles that include carbon may replace or be used in addition to or instead of the fullerene structures in order to form the pores.

Fullerene structures may be desirable in certain embodiments because the tempering process used to cure the sol gel film may combust (e.g., burn off partially or fully) the carbon-based structures, but leave the silica-based matrix intact. In certain examples, this may leave a controlled void space/volume where the structures (e.g., particles) had been prior to the heat treatment. In certain instances, the void space/volume may be controlled so as to tune the antireflective performance (e.g., tuning the refractive index) and/or improving the durability of the coating and/or coated article. In certain example embodiments, through the use of hollow carbon fullerene structures, the optical performance of an AR coating (e.g., formed via sol gel) may be improved and/or become more controllable. In certain cases, this may be due to the introduction of these hollow nanostructures into the coated layer prior to any heat treatment.

In certain cases, as FIGS. 2(a)-(e) indicate, fullerene-based carbon structural materials may include spherical structures known as buckyballs, nanotubes, and/or other shapes and geometries. Fullerene-based structures may have unique properties, which may make them potentially useful in many applications in nanotechnology, electronics, optics, other fields of materials science, and potentially in architectural fields. In certain example embodiments, fullerene structures may exhibit extraordinary strength and/or unique electrical properties. Fullerene structures alone are generally not reactive, in certain example embodiments. In some cases, fullerene structures may be efficient thermal conductors. These porous materials can also cover a wide range of pore sizes to accommodate fine tuning the structure of the coating to have the desired optical and/or durability properties.

FIG. 2(a) illustrates an example fullerene buckyball. For example, the diameter of a buckyball may be on the order of from about 1 to 2 nm.

FIG. 2(b) illustrates an example single-walled carbon nanotube. The diameter of a nanotube may be on the order of a few nanometers, or even less. However, in some cases, carbon-based nanotubes may be up to 18 cm in length. In certain cases, nanotubes have been constructed with a length-to-diameter ratio of up to about 132,000,000:1. This may be significantly larger than any other material in some cases.

FIG. 2(c) illustrates fullerenes of or including carbon nanobuds on nanotubes. Nanobuds, a more recently discovered type of fullerene geometry, form a material made from the combination of two allotropes of carbon—carbon nanotubes and spheroidal fullerenes. Carbon nanobuds may include spherical fullerenes covalently bonded to the outer sidewalls of the underlying nanotube, creating carbon nodules or buds attached to the nanotube body. These carbon nanoparticles can be used to form a geometrical template to create porosity in a (sol gel) silica-based matrix, in certain examples, for use as a broadband AR coating.

FIGS. 2(d) and 2(e) illustrate TEM (transmission electron microscope) pictures of different CNTs. FIG. 2(d) shows multi-walled carbon nanotubes, and FIG. 2(e) shows single-walled carbon nanotubes. In certain instances, fullerene structures (e.g., CNTs, etc.) may be available from America Dye Inc., and US Nano-Materials Inc., respectively.

In certain example embodiments, fullerene structures may be mixed with metal oxides and/or alkoxides in order to form a sol gel coating solution that may be deposited on a substrate through sol gel-type methods (e.g., casting, spin coating, dipping, curtain and roller, etc.). An example of a typical sol gel process is disclosed in U.S. Pat. No. 7,767,253, which is hereby incorporated by reference.

In certain example embodiments, a coating solution may be made by mixing a silane-based compound, fullerene structures, and an organic solvent. In certain example embodiments, the organic solvent may be of or include a low molecular weight alcohol such as n-propanol, isopropanol, ethanol, methanol, butanol, etc. However, in other embodiments, any organic solvent, including higher-molecular weight alcohols, may be used.

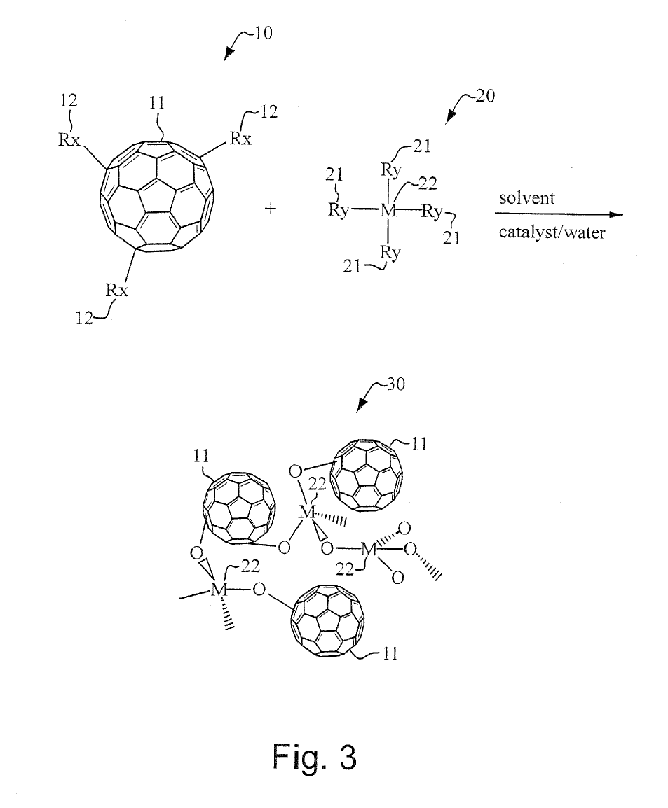

An example embodiment of a process for making an AR coating with fullerene nanoparticle structures is illustrated in FIG. 3. FIG. 3 shows the process of making a coated article comprising an AR coating from at least fullerene and metal alkoxide.

In the FIG. 3 example embodiment, an example method of making a metal (e.g., Si, Ti, Al, etc.) oxide and fullerene structure-based matrix is shown. The compounds indicated by 10 comprise fullerene structure(s) 11 having functional groups 12 comprising Rx. In certain embodiments, the Rx groups may be of or include a similar compound. In other example embodiments, some Rx groups may be different from each other. An example of an Rx group is OH (e.g., a hydroxyl group). However, functional groups 12 may comprise any material that will react with metal oxide 20.

Metal oxide/alkoxide compound 20 may comprise metal (M) 22, and groups 21 comprising Ry. In certain example embodiments, groups Ry may be of or include a similar compound. In other example embodiments, some groups Ry may be different from each other. An example of an Ry group is OR, or oxygen atoms bonded to carbon-based compounds. However, groups 21 may comprise any material(s) that will react with, or enable compound 20 to react with, functional groups 12 of fullerene structure(s) 11.

In certain example embodiments, metal oxide compound 20 may be hydrolyzed. In certain examples, the hydrolysis reaction may cause some groups 21 comprising Ry to become hydroxyl groups. In other examples, other reactions may cause at least portions of the Ry groups (e.g., the carbon-based compounds R may be split from an oxygen that is bonded to metal (M)) to cleave from the metal M atoms.

In certain examples, the hydrolyzed metal oxide-based compound 20 may be mixed with compound(s) 10 (e.g., fullerene structures 12 comprising functional groups 11), and solvent, and optionally catalysts, water, and/or further solvents, to make network 30. In certain example embodiments, network 30 (before and/or after any drying steps) may comprise a fullerene structures 11 and metal (M) 22-based network, wherein the fullerene structures and the metal atoms are bonded via oxygen atoms (e.g., from the Rx and/or Ry groups).

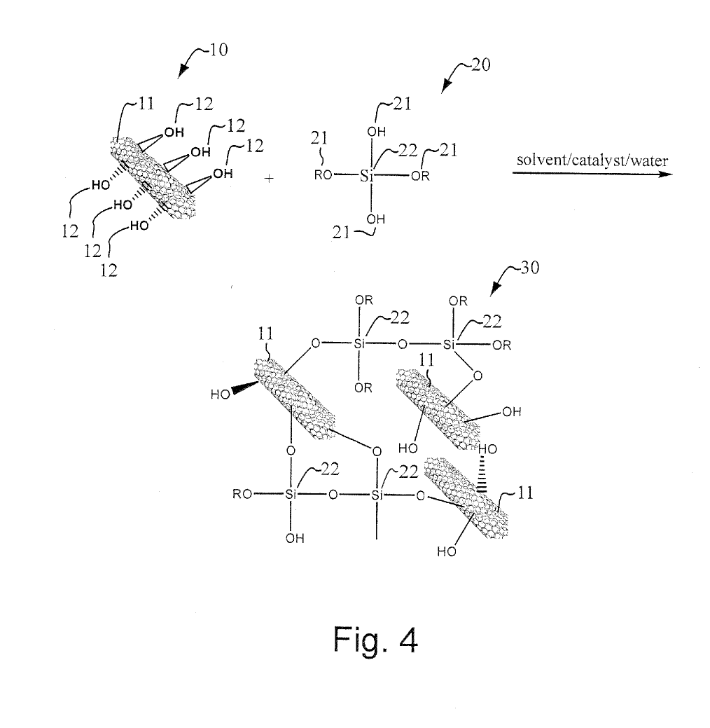

A further example method of making a silica and fullerene (CNT)-based matrix is shown in FIG. 4. In FIG. 4, metal oxide (20) comprises a hydrolyzied silane-based compound, and fullerene structure(s) 10 comprise(s) carbon nanotubes 11 with functional groups 12 comprising at least one (or more) hydroxyl group(s) (e.g., OH). Silane-based compound 20 is mixed with CNTs 11, and (e.g., through a condensation reaction) a silica and CNT-based matrix is produced. However, in some embodiments, the fullerene structures may have functional groups 12 other than OH groups attached thereto. Fullerene structures alone are generally not reactive, in certain example embodiments. However, the hydroxyl groups bonded to the fullerene structure may react with a silane-based compound. The silane-based compound 20 can be any compound comprising silicon with e.g., four reaction sites. The silane-based compound may comprise Si bonded to OH groups, OR groups (e.g., where R is a carbon-based compound such as a hydrocarbon), or a mix of OH and OR groups. In certain example embodiments, the silane-based material may comprise silicon atoms bonded to four “OR” groups, and upon hydrolysis, at least some of the R groups will be replaced by H atoms so as to facilitate the reaction between the silicon-based compound and the functional group of the carbon-based structures.

In an exemplary embodiment, a coating composition may comprise TEOS, CNTs (carbon nanotubes) with at least one (or more) hydroxyl groups, and an organic solvent such as ethanol, water and catalyst (acid and/or base). The coating solution may be deposited on a glass substrate via traditional sol gel coating methods, for example, dipping, spinning, curtain and roller, etc. Hydrolysis of metal alkoxides could be initiated by catalyst (acid or base) and water. Condensation of hydrolyzed metal alkoxides with functional fullerene and self-condensation of hydrolyzed metal alkoxides may occur prior to the formation of a sol, or in the sol. In this example, a reactive silane may be generated by the hydrolysis of TEOS. Then, at least some of the OH and/or OR sites of the silane may react with the hydroxyl functional groups of a fullerene structure in a condensation reaction. A network 30 comprising silica bonded to the fullerene structures (here, CNT) via oxygen results in certain embodiments. Specifically, one or more CNTs with one or more hydroxyl groups (compounds 10 in FIG. 4) combine with hydrolyzed TEOS (element 20) in a condensation reaction to produce a network of CNTs and TEOS (element 30).

Though TEOS is used as an exemplary example of a silica-based compound to form a silica-based network, any organic compound with silica, particularly with silicon and/or silane with four reaction sites, may be used in certain example embodiments. Furthermore, porous layers based on other metal oxides/alkoxides may be made this way as well.

In certain example embodiments, the process of forming a solid silica and fullerene-based network can be implemented by evaporation-induced self-assembly (EISA), with suitable solvents (e.g., low molecular weight organic solvents). Any by-products or unused reactants, such as water, solvent and/or hydrocarbons (e.g., from the R group of the silane and/or the solvent), that do not evaporate on their own as the coating is formed/immediately after, may be evaporated during a drying step. In certain example embodiments, after the coating is formed, the coating may be dried. In certain example embodiments, this drying may be performed in an oven and/or in any appropriate environment. The drying may be performed at a temperature of from about room temperature to 100° C., more preferably from about 50 to 80° C., and most preferably at a temperature of about 70° C. The drying may be performed for anywhere from a few seconds to a few minutes, more preferably from about 30 seconds to 5 minutes, and most preferably from about 1 to 2 minutes (at a temperature around 70° C.).

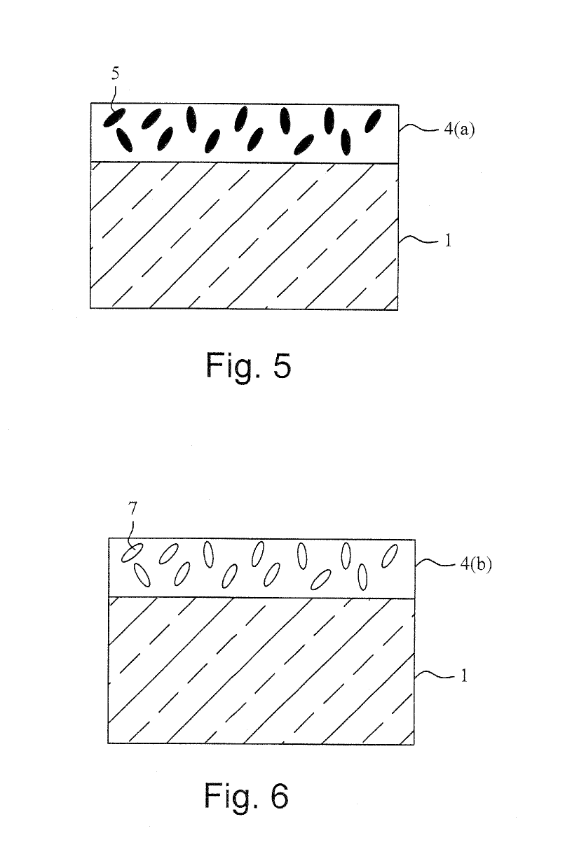

FIG. 5 illustrates a cross-sectional view of an example coated article comprising a silica-based layer 4(a) after it has dried. In certain example embodiments, the fullerene structures 5 are basically trapped in a solid silica-based matrix after drying. Depending on the type of fullerene structure used, the shape of the fullerene structures (or other carbon-based structures such as particles) in the matrix may be substantially closed and/or spherical (e.g., if buckyballs were used as the fullerene), or continuous (e.g. forming tunnels and/or wormholes), and/or a mix of the two (e.g., if more than one type of fullerene structure is used and/or if nanobuds are used). At this stage, after drying, but prior to any heat treating/thermal tempering, the amount of solids in the coating in certain example embodiments may be from about 0.2 to 2%, more preferably from about 0.5 to 1%, and most preferably from about 0.6 to 0.7% (by weight). The solids in the coating may comprise silica and carbon (e.g., fullerene structures). In certain example embodiments, the fullerenes may comprise from about 25 to 75%, more preferably from about 35 to 65%, and most preferably about 50% of the total solid content (by weight) of the coating/layer after drying prior to any heat treatment such as thermal tempering. Similarly, the silica may comprise from about 25 to 75%, more preferably from about 35 to 65%, and most preferably about 50% of the total solid content (by weight) of the coating/layer after drying prior to any heat treatment such as thermal tempering.

The thickness of the coating layer and its refractive index may be modified by the solid amount and composition of the sols. The pore size and/or porosity of the AR coating may be changed by (1) the geometric design of the fullerene nanoparticles used (e.g., CNT, buckyball, nanobuds, nanobuds on nanotubes, spheroids, and any other suitable carbon-based nanoparticles); and/or (2) the amount of the fullerene and metal alkoxides used.

In certain example embodiments, the fullerene structures may be reduced, substantially removed, and/or eliminated from the final layer, coating, or film during curing and/or heat treatment such as thermal tempering and/or chemical extract. More specifically, during a subsequent heating step after the layer has been deposited, the carbon may combust, and may leave pores (e.g., empty spaces) where the fullerene structures previously were located prior to the heat treating.

FIG. 6 illustrates an example AR layer 4(b) after the fullerene structures have been substantially removed by combusting during the heat treating, creating pores 7. In certain example embodiments, the glass substrate 1 comprising the layer 4(a) comprising a silica and fullerene-based matrix may be thermally and/or chemically tempered to form layer 4(b). Thus, by thermally tempering a coated substrate comprising a silica and fullerene-based layer, a porous silica anti-reflective layer may be formed. This porous silica anti-reflective layer may advantageously have pores that are very small in at least diameter (e.g., on the scale of 1 to 2 nm), and various shapes, enabling the coating to have an improved durability and optical performances, in certain example embodiments. Furthermore, the pores may be formed so as to be closed and/or tunnel-like, depending on the desired properties.

In addition to increasing the strength of the glass, the heat treating/tempering may also be performed at such a temperature that the carbon (and therefore the fullerene structures) combust. In certain example embodiments, heat treating/tempering may be performed at a temperature of at least about 500° C., more preferably at least about 560° C., even more preferably at least about 580 or 600° C., and most preferably the coated substrate is tempered at a temperature of at least about 625-700° C., for a period of from about 1 to 20 min, more preferably from about 2 to 10 min, and most preferably for about 3 to 5 minutes. In other embodiments, heating may be performed at any temperature and for any duration sufficient to cause the carbon in the layer to combust.

In certain example embodiments, the carbon in the layer may react with the heat and moisture in the environment during tempering, and may diffuse out of the coating as CO, CO₂, and/or H₂O vapor. The combustion of the carbon (and consequently the fullerene structures) may leave pores (e.g., empty spaces) in the silica-based matrix where the fullerene structures previously were located.

In certain example embodiments, some traces of carbon (C) may remain in the layer following the heat treatment. In certain example embodiments, the anti-reflective layer may comprise from about 0.001 to 10% C, more preferably from about 0.001 to 5% C, and most preferably from about 0.001 to 1% C, after heating/tempering (by weight).

In certain example embodiments, the refractive index of the anti-reflective layer may be from about 1.15 to 1.40, more preferably from about 1.17 to 1.3, and most preferably from about 1.20 to 1.26, with an example refractive index being about 1.22. In certain examples, the thickness of a single-layer anti-reflective coating may be from about 50 to 500 nm, more preferably from about 50 to 200 nm, and most preferably from about 120 to 160 nm, with an example thickness being about 140 nm. However, in certain instances, the refractive index may be dependent upon the coating's thickness. In certain examples, a thicker anti-reflective coating will have a higher refractive index, and a thinner anti-reflective coating may have a lower refractive index. Therefore, a thickness of the coating may vary based upon the desired refractive index.

In certain example embodiments, to achieve a desirable refractive index, the porosity of the anti-reflective coating may be from about 15 to 50%, more preferably from about 20 to 45%, and most preferably from about 27.6 to 36%. The porosity is a measure of the percent of empty space within the coating layer, by volume. In certain example embodiments, the pore size may be as small as 1 nm, or even less. The pore size may range from about 0.1 nm to 50 nm, more preferably from about 0.5 nm to 25 nm, even more preferably from about 1 nm to 20 nm, and most preferably from about 2.4 to 10.3 nm. Pore size, at least in terms of diameter, may be as small as the smallest fullerene will permit. Higher porosity usually leads to lower index but decreased durability. However, it has been advantageously found that by utilizing fullerene structures with very small diameters, a desired porosity (in terms of % of empty space in the coating) may be obtained with a reduced pore size, thereby increasing the durability of the coating.

The porous silica-based layer may be used as a single-layer anti-reflective coating in certain example embodiments. However, in other embodiments, under layers, barrier layers, functional layers, and/or protective overcoats may also be deposited on the glass substrate, over or under the anti-reflective layer described herein in certain examples.

A porous silica-based anti-reflective layer according to certain example embodiments may be used as a broadband anti-reflective coating in electronic devices and/or windows. However, coatings as described herein may also effectively reduce the reflection of visible light. Thus, in addition to photovoltaic devices and solar cells, these coated articles may be used as windows, in lighting applications, in handheld electronic devices, display devices, display cases, monitors, screens, TVs, and the like.

Although TEOS is given as an example silica-precursor used to form a silica-based matrix, almost any other silica precursor may be used in different example embodiments. In certain cases, all that is necessary is a silicon-based compound comprising Si with four bond sites (e.g., a silane). Though a porous silica-based anti-reflective coating is described in many of the examples, a porous layer of any composition may be made according to certain methods disclosed herein. For example, if a glass substrate were treated so as to have a higher index of refraction at its surface, and a porous layer with a higher index of refraction could therefore be used to sufficiently reduce reflection, a titanium oxide and/or aluminum oxide-based matrix with fullerenes that are combusted to produce a porous layer could also be made.

In still further example embodiments, other metal oxide and/or alkoxide precursors may be used. Porous coatings of other metal oxide and/or alkoxide precursors may be used for other applications. If reducing reflection is not the primary goal, or if the coating is used on a substrate with an index of refraction different from that of glass, other metal oxides may be reacted with reactive groups attached to fullerene structures to form other types of metal oxide-fullerene matrices. These matrices may subsequently be heated/tempered to form porous metal oxide coatings in certain embodiments. In other words, porous metal oxide-based matrices of any metal, for any purpose, may be formed by utilizing the space left by combusted fullerenes.

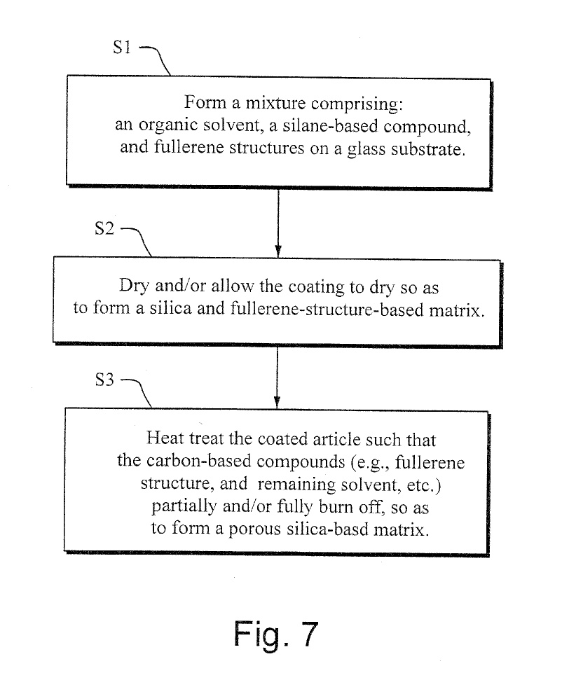

FIG. 7 illustrates an example method of making a porous metal oxide-based layer (e.g., a porous silica-based layer). In S1, a coating solution comprising a silane-based compound, fullerene(s) with at least one (but possibly more) hydroxyl group may be deposited on a glass substrate. In certain cases, the coating solution may be deposited by any appropriate sol gel deposition technique.

In S2, the coating is dried, and any remaining solvent, water, catalyst, unreacted reagent, and/or other by-products may be evaporated. A layer comprising a matrix of silica and fullerenes remains.

In S3, the coated article is thermally tempered such that the fullerenes (and any other carbon-based compounds remaining in the layer) combust, and diffuse out of the layer; resulting in a silica-based matrix with pores where the fullerene structures previously had been located. The layer may be used as a single-layer anti-reflective coating in certain example embodiments. However, in other embodiments, under layers, barrier layers, functional layers, and/or protective overcoats may also be deposited on the glass substrate, over or under the anti-reflective layer described herein in certain examples.

In certain example embodiments, the method may further comprise an intermediate heating layer between drying and heat treating. In certain examples, particularly where solvents and/or silane-based compounds with higher molecular weights are used, an intermediate heating step may ensure all of the by-products and/or unused reactants or solvents are fully evaporated prior to any relocation of the coated article for tempering that may be necessary.

As explained above, substrate 1 may be a clear, green, bronze, or blue-green glass substrate from about 1.0 to 10.0 mm thick, and more preferably from about 1.0 mm to 3.5 mm thick. In certain electronic device applications, the glass substrate may be thinner. In other example embodiments, particularly in solar and/or photovoltaic applications, a low-iron glass substrate such as that described in U.S. Pat. Nos. 7,893,350 or 7,700,870, which are hereby incorporated by reference, may be used.

Certain terms are prevalently used in the glass coating art, particularly when defining the properties and solar management characteristics of coated glass. Such terms are used herein in accordance with their well known meaning (unless expressly stated to the contrary). For example, the terms “heat treatment” and “heat treating” as used herein mean heating the article to a temperature sufficient to achieve thermal tempering, bending, and/or heat strengthening of the glass inclusive article. This definition includes, for example, heating a coated article in an oven or furnace at a temperature of least about 560, 580 or 600 degrees C., and in some cases even higher, for a sufficient period to allow tempering, bending, and/or heat strengthening, and also includes the aforesaid test for thermal stability at about 625-700 degrees C. In some instances, the HT may be for at least about 4 or 5 minutes, or more.

In certain example embodiments, there is provided a method of making a coated article including a broadband anti-reflective coating comprising porous silica on, directly or indirectly, a glass substrate. A coating solution comprising a silane, fullerene structures comprising at least one functional group, and a solvent is formed. A coating is formed on, directly or indirectly, the glass substrate by disposing the coating solution on the glass substrate. The coating is dried and/or allowed to dry so as to form a coating comprising silica and a fullerene structure-based matrix on the glass substrate. The glass substrate with the coating comprising silica and fullerene structure-based matrix thereon is heat treated so as to combust the fullerene structures, leaving pores following said heat treating in locations where the fullerene structures had been prior to said heat treating, so as to form an anti-reflective coating comprising a porous silica-based matrix on the glass substrate.

In addition to the features of the preceding paragraph, in certain example embodiments, a porosity of the anti-reflective coating may be from about 20 to 45%.

In addition to the features of either of the two preceding paragraphs, in certain example embodiments, the fullerene structures may comprise carbon nanotubes (CNTs).

In addition to the features of any of the three preceding paragraphs, in certain example embodiments, the fullerene structures may comprise carbon nanobuds.

In addition to the features of any of the four preceding paragraphs, in certain example embodiments, the fullerene structures may comprise buckyballs.

In addition to the features of any of the five preceding paragraphs, in certain example embodiments, the fullerene structures may comprise one or more of CNTs, carbon nanobuds, and buckyballs.

In addition to the features of any of the six preceding paragraphs, in certain example embodiments, the functional group of the fullerene structures may comprise a hydroxyl group.

In addition to the features of any of the seven preceding paragraphs, in certain example embodiments, the silane may comprise tetraethyl orthosilicate (TEAS).

In addition to the features of any of the eight preceding paragraphs, in certain example embodiments, the solvent comprises ethanol.

In addition to the features of any of the nine preceding paragraphs, in certain example embodiments, a refractive index of the anti-reflective coating is from about 1.20 to 1.26.

In addition to the features of any of the ten preceding paragraphs, in certain example embodiments, a thickness of the anti-reflective coating is from about 120 to 160 nm.

In certain example embodiments, a method of making an anti-reflective coating is provided. A coating solution comprising at least a metal oxide, carbon-inclusive structures, and a solvent is provided. The coating solution is disposed on a glass substrate so as to form a coating comprising a metal oxide and carbon-inclusive structure-based matrix. The substrate is heat treated with the coating thereon so as to combust the carbon-inclusive structures, so that after the heat treating pores are located substantially where the carbon-inclusive structures had been prior to the heat treating, so as to form a coating comprising a porous metal oxide.

In addition to the features of the preceding paragraph, in certain example embodiments, the metal oxide may comprise a silane.

In addition to the features of either of the two preceding paragraphs, in certain example embodiments, the carbon-inclusive structures may comprise fullerene structures.

In addition to the features of the preceding paragraph, in certain example embodiments, at least some of the fullerene structures may comprise a functional group.

In addition to the features of the preceding paragraph, in certain example embodiments, the functional group may be a hydroxyl group.

In addition to the features of any of the five preceding paragraphs, in certain example embodiments, the heat treating is performed at a temperature of at least about 560° C.

In certain example embodiments, a coated article is provided. A glass substrate is provided. A coating is supported by the glass substrate, with the coating comprising a matrix comprising fullerene structures and silica.

In addition to the features of the preceding paragraph, in certain example embodiments, at least some of the fullerene structures may have a diameter of less than about 2 nm.

In addition to the features of either of the two preceding paragraphs, in certain example embodiments, the fullerene structures may comprise at least one of buckyballs, carbon nanotubes, and carbon nanobuds.

In certain example embodiments, a coated article is provided. A glass substrate with an anti-reflective coating disposed thereon is provided. The anti-reflective coating comprises porous silica, and comprises pores having carbon residue.

In addition to the features of the preceding paragraph, in certain example embodiments, the anti-reflective coating has a porosity of from about 15 to 50%, more preferably from about 20 to 45%, and most preferably from about 27.6 to 36%.

In certain example embodiments, there is provided a method of making a coated article including an anti-reflective coating comprising porous silica on, directly or indirectly, a glass substrate. A coating solution comprising a silane, carbon-inclusive structures, and a solvent is formed. A coating is formed on, directly or indirectly, the glass substrate by disposing the coating solution on the glass substrate. The coating is dried and/or allowed to dry so as to form a coating comprising silica and a matrix comprising the carbon-inclusive structures on the glass substrate. The glass substrate is heat treated with the coating comprising silica and the matrix comprising the carbon-inclusive structures thereon so as to combust the carbon-inclusive structures, leaving spaces and/or pores following said heat treating in locations where the carbon-inclusive structures had been prior to said heat treating, so as to form an anti-reflective coating comprising a silica-based matrix on the glass substrate.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a coated article including a broadband anti-reflective coating comprising porous silica on, directly or indirectly, a glass substrate, the method comprising:
forming a coating solution comprising a silane, fullerene structures comprising at least one functional group, and a solvent;
forming a coating on, directly or indirectly, the glass substrate by disposing the coating solution on the glass substrate;
drying the coating and/or allowing the coating to dry so as to form a coating comprising silica and a fullerene structure-based matrix on the glass substrate;
heat treating the glass substrate with the coating comprising silica and fullerene structure-based matrix thereon so as to combust the fullerene structures, leaving pores following said heat treating in locations where the fullerene structures had been prior to said heat treating, so as to form an anti-reflective coating comprising a porous silica-based matrix on the glass substrate.

2. The method of claim 1, wherein a porosity of the anti-reflective coating is from about 20 to 45%.

3. The method of claim 1, wherein the fullerene structures comprise carbon nanotubes (CNTs).

4. The method of claim 1, wherein the fullerene structures comprise carbon nanobuds.

5. The method of claim 1, wherein the fullerene structures comprise buckyballs.

6. The method of claim 1, wherein the fullerene structures comprise one or more of CNTs, carbon nanobuds, and buckyballs.

7. The method of claim 1, wherein the functional group of the fullerene structures comprises a hydroxyl group.

8. The method of claim 1, wherein the silane comprises tetraethyl orthosilicate (TEOS).

9. The method of claim 1, wherein the solvent comprises ethanol.

10. The method of claim 1, wherein a refractive index of the anti-reflective coating is from about 1.20 to 1.26.

11. The method of claim 1, wherein a thickness of the anti-reflective coating is from about 120 to 160 nm.

12. A method of making an anti-reflective coating, the method comprising:
providing a coating solution comprising at least a metal oxide, carbon-inclusive structures, and a solvent;
disposing the coating solution on a glass substrate so as to form a coating comprising a metal oxide and carbon-inclusive structure-based matrix; and
heat treating the substrate with the coating thereon so as to combust the carbon-inclusive structures, so that after the heat treating pores are located substantially where the carbon-inclusive structures had been prior to the heat treating, so as to form a coating comprising a porous metal oxide.

13. The method of claim 12, wherein the metal oxide comprises a silane.

14. The method of claim 12, wherein the carbon-inclusive structures comprise fullerene structures.

15. The method of claim 14, wherein at least some of the fullerene structures comprise a functional group.

16. The method of claim 15, wherein the functional group is a hydroxyl group.

17. The method of claim 12, wherein the heat treating is performed at a temperature of at least about 560° C.

18. A coated article comprising:
a glass substrate; and
a coating supported by the glass substrate, the coating comprising a matrix comprising fullerene structures and silica.

19. The coated article of claim 18, wherein at least some of the fullerene structures have a diameter of less than about 2 nm.

20. The coated article of claim 18, wherein the fullerene structures comprise at least one of buckyballs, carbon nanotubes, and carbon nanobuds.

21. A coated article comprising:
a glass substrate with an anti-reflective coating disposed thereon;
wherein the anti-reflective coating comprises porous silica, and comprises pores having carbon residue.

22. The coated article of claim 21, wherein the anti-reflective coating has a porosity of from about 15 to 50%, more preferably from about 20 to 45%, and most preferably from about 27.6 to 36%.

23. A method of making a coated article including an anti-reflective coating comprising porous silica on, directly or indirectly, a glass substrate, the method comprising:
forming a coating solution comprising a silane, carbon-inclusive structures, and a solvent;
forming a coating on, directly or indirectly, the glass substrate by disposing the coating solution on the glass substrate;
drying the coating and/or allowing the coating to dry so as to form a coating comprising silica and a matrix comprising the carbon-inclusive structures on the glass substrate;
heat treating the glass substrate with the coating comprising silica and the matrix comprising the carbon-inclusive structures thereon so as to combust the carbon-inclusive structures, leaving spaces and/or pores following said heat treating in locations where the carbon-inclusive structures had been prior to said heat treating, so as to form an anti-reflective coating comprising a silica-based matrix on the glass substrate.
